(19) United States
(12) Patent Application Publication
(10) Pub. No.: US 2011/0113534 A1
(43) Pub. Date: May 19, 2011

(54) Impact Resistant Composite Article

(75) Inventors: BRYAN BENEDICT SAUER, Boothwyn, PA (US); Jeffrey Alan Hanks, Midlothian, VA (US)

(73) Assignee: E.I.DU PONT DE NEMOURS AND COMPANY, Wilmington, DE (US)

(21) Appl. No.: 12/619,799

(22) Filed: Nov. 17, 2009

(51) Int. Cl. A42B 3/00; B32B 7/02; F41H 5/00

(52) U.S. Cl. 2/411; 428/212; 428/212

(57) ABSTRACT

An impact resistant composite article has at least two or more fibrous fabric layers and a polymeric layer disposed between at least some of the fabric layers. The peel strength measured at 20° C. between the fabric layer an adjacent polymeric layer after pressing for 30 minutes at 500 psi and 160° C. is less than 1 kg/cm, and where the weight % of polymeric resin relative to the resin plus fabric is greater than 5%.

### FIELD OF THE INVENTION

This invention relates to lightweight armor composite structures comprising an acid copolymer and a fabric comprising impact resistant fibers.

### BACKGROUND

Ballistic articles such as bulletproof vests, helmets, structural members of helicopters and other military equipment, vehicle panels, briefcases, raincoats and umbrellas containing high strength fibers are known. Fibers conventionally used include aramid fibers such as poly(phenylenediamine terephthalamide); graphite fibers; nylon fibers; ceramic fibers; glass fibers and the like. For many applications, such as vests or parts of vests, the fibers are used in a woven or knitted fabric. Fibers may be encapsulated or embedded in a matrix material.

Phenolic or modified polyester can also be added to these high strain ballistic fabrics in order to form composites in which the resin does little more than keep out water. Often a nonbonding rubber latex is added to enhance nonbonding to the high strain, high tenacity fiber (such as Kevlar®), in order that the high strain fiber breaks free of the composite matrix under impact and goes into tension along its length, immediately and thus carrying the impact load over as large an area as possible. The stopping power of the ballistic fabric stack is thereby increased.

Ionomers have been used to form composites with ballistic fibers. In U.S. Pat. No. 4,879,165 is disclosed an armor structure or high impact structure comprising a plurality of zones, at least one zone comprising an extruded ionomer resin. For example one ionomer or ionomer resin of the '165 invention is obtained by combining a copolymer of ethylene-methacrylic acid or ethylene-acrylic acid and a polyamine which contains at least one R—CH₂—N H₂ group, and the R may contain: (—CH₂ NH₂)ₓ; (—NH₂)ₓ; or (R′R″NH)_{y}, where x=1 or more, and y=0 or more. R′ and R″ may be any organic groups.

The present inventors have discovered compositions that show a significant improvement in ballistic performance over the existing art in this area.

### SUMMARY OF THE INVENTION

The present invention is directed to an impact resistant composite article comprising two or more fibrous fabric layers and a polymeric layer disposed between at least some of the fabric layers. The peel strength measured at 20° C. between the fabric layer and the polymeric layer after pressing for 20 minutes at 500 psi and 160° C. is less than 1 kg/cm, and where the weight % of polymeric resin relative to the resin plus fabric is between 8% and 15% and preferably between 10% and 13%. The polymeric layer comprises a material selected from the group consisting of a thermoplastic material, a blend of thermoplastic materials, a thermosetting material, and a blend of thermosetting materials, and where the polymeric layer does not contain a thermoplastic material and a thermosetting material.

### DESCRIPTION OF THE INVENTION

In the present description, the terms “fibrous fabric” and “fabric” are synonymous. By “composite article” is meant any type of construction, such as a panel, whether flat or otherwise that is described by this invention. A composite article may also include a product formed or molded from the invention, for example a helmet.

The present invention is directed to an impact resistant composite article comprising two or more fibrous fabric layers and a polymeric layer disposed between at least some of the fabric layers, in which the peel strength measured under a 180 degree angle (ASTM D 1876-08) and at 20° C. between the fabric layer and the polymeric layer after pressing for 20 minutes at 500 psi and 160° C. is less than 1 kg/cm, and where the weight percent of polymeric resin relative to the resin plus fabric is between 8% and 15% and preferably between 10% and 13%. The polymeric layer comprises a material selected from the group consisting of a thermoplastic material, a blend of thermoplastic materials, a thermosetting material, and a blend of thermosetting materials, and where the polymeric layer does not contain a thermoplastic material and a thermosetting material.

The fabric employed in the invention comprises fiber that can be woven or nonwoven and can further comprise an aramid, even poly (p-phenylene terephthalmide), or ultra high molecular weight high density polyethylene (UHMWPE.). By nonwoven it is meant that in some embodiments the fabric can be a unidirectional fabric, a multi-axial fabric, or a three-dimensional fabric, either of these provided with or without binder. The multi-axial fabric can have layers of yarn oriented at an angle with respect to adjacent layer(s), and these layers can comprise unidirectional arrays of yarns. The three-dimensional fabrics can also comprise unidirectional arrays of yarns.

For the purposes of the present invention, fiber is an elongate body the length dimension of which is much greater than the transverse dimensions of width and thickness. Accordingly, the term fiber includes monofilament fiber, multifilament fiber, ribbon, strip, a plurality of any one or combinations thereof and the like having regular or irregular cross-section.

Composite articles of the present invention can comprise a fiber network comprising highly oriented ultra-high molecular weight polyethylene fiber (UHMWPE), highly oriented ultra-high molecular weight polypropylene fiber (UHMWPP), aramid fiber, polyvinyl alcohol fiber, polyazole fiber or combinations or blends, including mixtures of fibers made of different materials or blends of different polymers in one fiber. U.S. Pat. No. 4,457,985 generally discusses oriented ultra high molecular weight polyethylene and polypropylene fibers, the disclosure of which is hereby incorporated by reference to the extent not inconsistent herewith. In the case of polyethylene, suitable fibers are those highly oriented fibers of weight average molecular weight of at least about 500,000, preferably at least about one million and more preferably between about two million and about six million. Known as extended chain polyethylene (ECPE) fibers, such fibers may be produced from polyethylene solution spinning processes described, for example, in U.S. Pat. No. 4,137,394 to Meihuzen et al. or U.S. Pat. No. 4,356,138 to Kavesh et al., or spun from a solution to form a gel structure as described in German Off. No. 3,004,699, GB No. 2051667, and especially as described in application Ser. No. 259,266 of Kavesh et al. filed Apr. 30, 1981 and application Ser. No. 359,019 (continuation-in-part of Ser. No. 259,266) (see EPA No. 64,167, published Nov. 10, 1982).

As used herein, the term polyethylene shall mean a predominantly linear polyethylene material that may contain minor amounts of chain branching or comonomers not exceeding 5 modifying units per 100 main chain carbon atoms, and that may also contain admixed therewith not more than about 25 wt % of one or more polymeric additives such as alkene-1-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as anti-oxidants, lubricants, ultra-violet screening agents, colorants and the like which are commonly incorporated therewith.

Depending upon the fiber-forming technique, the draw ratio and temperatures, and other conditions, a variety of properties can be imparted to these fibers. The tenacity of the fibers is ordinarily at least about 15 grams/denier, preferably at least about 20 grams/denier, more preferably at least about 30 grams/denier and most preferably at least about 40 grams/denier. Similarly, the tensile modulus of the fibers, as measured by an Instron tensile testing machine, is ordinarily at least about 300 grams/denier, preferably at least about 500 grams/denier, more preferably at least about 1,000 grams/denier and most preferably at least about 1,500 grams/denier. These highest values for tensile modulus and tenacity are generally obtainable only by employing solution spun or gel fiber processes. In addition, many ECPE fibers have melting points higher than the melting point of the polymer from which they were formed. Thus, for example, whereas ultra-high molecular weight polyethylenes of 500,000, one million and two million generally have melting points in the bulk of 134° C., the ECPE fibers made of these materials have melting points of 145° C. or higher. The increase in melting point reflects a higher crystalline orientation of the fibers as compared to the bulk polymer.

Improved ballistic resistant articles are formed when polyethylene fibers having a weight average molecular weight of at least about 500,000, a modulus of at least about 500 and a tenacity of at least about 15 g/denier are employed. Cf. John V. E. Hansen and Roy C. Laible in “Flexible Body Armor Materials,” Fiber Frontiers ACS Conference, Jun. 10-12, 1974 (ballistically resistant high strength fibers must exhibit high melting point and high resistance to cutting or shearing); Roy C. Laible, Ballistic Materials and Penetration Mechanics, 1980 (noting that nylon and polyester may be limited in their ballistic effectiveness due to the lower melting point); and “The Application of High Modulus Fibers to Ballistic Protection”, R. C. Laible, et al., J. Macromel. Sci. Chem., A7(1), pp. 295-322, 1973 (the importance of a high degree of heat resistance is again discussed).

In the case of polypropylene, highly oriented polypropylene fibers of weight average molecular weight at least about 750,000, preferably at least about one million and more preferably at least about two million may be used. Ultra high molecular weight polypropylene may be formed into reasonably highly oriented fibers by the techniques prescribed in the various references referred to above, and especially by the technique of U.S. Ser. No. 259,266, filed Apr. 30, 1981, and the continuations-in-part thereof, both to Kavesh et al. Since polypropylene is a much less crystalline material than polyethylene and contains pendant methyl groups, tenacity values achievable with polypropylene are generally substantially lower than the corresponding values for polyethylene. Accordingly, a suitable tenacity is at least about 8 grams/denier, with a preferred tenacity being at least about 11 grams/denier. The tensile modulus for polypropylene is at least about 160 grams/denier, preferably at least about 200 grams/denier. The melting point of the polypropylene is generally raised several degrees by the orientation process, such that the polypropylene fiber preferably has a main melting point of at least about 168°., more preferably at least about 170° C. Employing fibers having a weight average molecular weight of at least about 750,000 coupled with the preferred ranges for the above-described parameters (modulus and tenacity) can provide advantageously improved performance in the final article especially in ballistic resistant articles. C.f. Laible, Ballistic Materials and Penetration Mechanics, supra, at p. 81 (no successful treatment has been developed to bring the ballistic resistance of polypropylene up to levels predicated from the yarn stress-strain properties); and the relative effectiveness of NTIS publication ADA018 958, “New Materials in Construction for Improved Helmets”, A. L. Alesi et al. [wherein a multilayer highly oriented polypropylene film material (without matrix), referred to as “XP”, was evaluated against an aramid fiber (with a phenolic/polyvinyl butyral resin matrix); the aramid system was judged to have the most promising combination of superior performance and a minimum of problems for combat helmet development].

Aramid fiber is formed principally from aromatic polyamide. Aromatic polyamide fibers having a modulus of at least about 400 g/denier and tenacity of at least about 18 g/denier are particularly useful for incorporation into composites of this invention. For example, poly(phenylenediamine terephthalamide) fibers produced commercially by E. I. du Pont de Nemours & Company under the trade names of Kevlar® 29 and Kevlar® 49 and having moderately high moduli and tenacity values are particularly useful in forming ballistic resistant composites. (Kevlar® 29 has 500 g/denier and 22 g/denier and Kevlar® 49 has 1000 g/denier and 22 g/denier as values of modulus and tenacity, respectively).

In the case of polyvinyl alcohol (PV-OH), PV-OH fibers having a weight average molecular weight of at least about 500,000, preferably at least about 750,000, more preferably between about 1,000,000 and about 4,000,000 and most preferably between about 1,500,000 and about 2,500,000 may be employed in the present invention. Usable fibers should have a modulus of at least about 160 g/denier, preferably at least about 200 g/denier, more preferably at least about 300 g/denier, and a tenacity of at least about 7 g/denier, preferably at least about 10 g/denier and more preferably at least about 14 g/denier and most preferably at least about 17 g/denier. PV-OH fibers having a weight average molecular weight of at least about 500,000, a tenacity of at least about 200 g/denier and a modulus of at least about 10 g/denier are particularly useful in producing ballistic resistant composites. PV-OH fibers having such properties can be produced, for example, by the process disclosed in U.S. Pat. application Ser. No. 569,818, filed Jan. 11, 1984, to Kwon et al. and commonly assigned.

In the case of polyazoles, some preferred embodiments of polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures.

Preferred polybenzazoles are polybenzimidazoles, polybenzothiazoles, and polybenzoxazoles and more preferably such polymers that can form fibers having yarn tenacities of 30 gpd or greater. If the polybenzazole is a polybenzothioazole, preferably it is poly(p-phenylene benzobisthiazole). If the polybenzazole is a polybenzoxazole, preferably it is poly(p-phenylene benzobisoxazole) and more preferably poly(p-phenylene-2,6-benzobisoxazole) called PBO.

Preferred polypyridazoles are polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. A preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures.

The fabric employed in the invention can optionally be finished with a repellant material. By “repellant material” is meant a hydrophobic material that resists wetting by aqueous media, an agent comprising fluorine and carbon atoms being preferred. For example the fabric can be at least partially coated with a fluorinated material. Alternatively the fluorinated material is selected from the group consisting of Zonyl® D fabric fluoridizer consisting of fluorinated methacrylate copolymers or Zonyl® 8300 fabric protector consisting of fluorinated acrylate copolymers. The treatment of fabrics with such fluorinated polymers and oligomers is common in the trade and is not limited to these chemicals. One skilled in the art will be able to choose a suitable treatment.

The water-repellent coating employed in the invention can in principle be any agent that repels water and solvents. The finish may be applied to the fiber in a variety of ways. One method is to apply the neat resin of the coating material to the stretched high modulus fibers either as a liquid, a sticky solid or particles in suspension or as a fluidized bed. Alternatively, the finish may be applied as a solution or emulsion in a suitable solvent which does not adversely affect the properties of the fiber at the temperature of application. While any liquid capable of dissolving or dispersing the coating polymer may be used, preferred groups of solvents include water, paraffin oils, aromatic solvents or hydrocarbon solvents, with illustrative specific solvents including paraffin oil, xylene, toluene and octane. If the fiber achieves its final properties only after a stretching operation or other manipulative process, e.g. solvent exchanging, drying or the like, it is contemplated that the finish may be applied to the precursor material. In this embodiment, the desired and preferred tenacity, modulus and other properties of the fiber should be judged by continuing the manipulative process on the fiber precursor in a manner corresponding to that employed on the finished fiber precursor. Thus, for example, if the coating is applied to the xerogel fiber described in U.S. application Ser. No. 572,607 of Kavesh et al., and the coated xerogel fiber is then stretched under defined temperature and stretch ratio conditions, the applicable fiber tenacity and fiber modulus values would be the measured values of an uncoated xerogel fiber which is similarly stretched.

A preferred coating technique is to form a network layer and then dip the network into a bath of a solution containing the coating material. Evaporation of the solvent produces a finished fabric. The dipping procedure may be repeated as required to place a desired amount of coating on the fibers.

The water-repellent coating employed in the invention can in principle be any agent that repels water and that can be applied to the aramid fiber, an agent comprising fluorine and carbon atoms being preferred. A preferred water-repellent coating of the invention is one comprising a fluoropolymer, and especially a mixture of fluoroacrylate polymers, e.g., OLEOPHOBOL SM® from Ciba Spezialitätenchemie Pfersee GmbH, Langweid, Germany.

The water-repellent agent may in addition contain an antistatic agent, such LEOMIN AN® from CLARIANT GmbH, Textile Leather Products Division, Textile Chemicals BU, Frankfurt Main, Germany.

The water-repellent finish applied on an aramid fiber of the invention can be used in pure form, provided it satisfies the above-mentioned criteria. On account of easier dosing of the required amount of water-repellent agent on to the fiber, however, it is advantageous to apply the water-repellent agent to the aramid fiber in the form of a solution or dispersion or preferably an aqueous emulsion, the water-repellent agent being present in the aqueous emulsion preferably in a concentration in the range of 20-300 g/l.

For application of the water-repellent finish to an aramid fiber, any method is suitable in principle that allows the water-repellant agent in the chosen formulation to be distributed on the surface of the fiber. For example, the water-repellent agent formulation can be applied as a thin film on a roller and the aramid fiber passed through the film. Alternatively, the water-repellent agent formulation can be sprayed on to the aramid fiber. The water-repellent agent formulation can also be applied to the fiber using a pump and a pin, slit or block applicator.

The application of finish is effected preferably by passing the aramid fiber over a roller immersed in a bath containing the aqueous emulsion of the water-repellent agent, the emulsion preferably having a temperature in the range 15-35° C.

The drying of the aramid fiber after application of finish is performed within ranges of temperature and of drying time that suffice to ensure that the aramid fiber does not agglutinate in the subsequent winding up. The parameter ranges for temperature and drying time are also determined by the requirements of the selected application method. If the water-repellent agent is applied on the aramid fiber in the aramid fiber spinning process, for example, after the fiber has left the wash bath, the ranges of temperature and drying time will be determined by the spinning speed and the structural features of the spinning facility. If the aramid fiber resulting from step b) is dried at a temperature in the range of 130-210° C. and for a period in the range of 5-15 seconds, the drying yields excellent results, for which reason the above-mentioned ranges are preferred.

The finished fabric is heat treated, preferably until the water absorption of the fabric is reduced. The ranges of duration and temperature required for the heat treatment are determined essentially by the water-repellent agent applied in the coating step. In many cases a temperature in the range of 120-200° C. and a duration of 30-120 seconds are adequate for heat treatment.

A proportion of water-repellent agent in the range of 0.001-0.02 g of water-repellent agent per g of fabric, and particularly of 0.006-0.015 g of water-repellent agent per g of fabric results in particularly high hydrophobic efficiency coupled with high antiballistic efficiency in the dry and wet states.

The polymeric layer used in the present invention can comprise either a thermoplastic resin or a blend thereof, or a thermosetting resin, or a blend thereof, but not both a thermoplastic and a thermosetting resin together. The polymer of the polymer layer can be any polymer that provides the required level of adhesion with the fabric. For example ethylene copolymers with acid monomers can be used, or alternatively any polyester of polyamide may be used. One skilled in the art will be able with minimal experimentation to specify a suitable polymer.

The ethylene copolymers that may be utilized in the present invention can be neutralized with an ion selected form the group consisting of sodium, potassium, lithium, silver, mercury, copper and the like and mixtures thereof. Useful divalent metallic ions include, but are not limited to, ions of beryllium, magnesium, calcium, strontium, barium, copper, cadmium, mercury, tin, lead, iron, cobalt, nickel, zinc and the like and mixtures therefrom. Useful trivalent metallic ions include, but are not limited to, ions of aluminum, scandium, iron, yttrium and the like and mixtures therefrom. Useful multivalent metallic ions include, but are not limited to, ions of titanium, zirconium, hafnium, vanadium, tantalum, tungsten, chromium, cerium, iron and the like and mixtures therefrom. It is noted that when the metallic ion is multivalent, complexing agents, such as stearate, oleate, salicylate, and phenolate radicals may be included, as disclosed within U.S. Pat. No. 3,404,134. The metallic ions used herein are preferably monovalent or divalent metallic ions. More preferably, the metallic ions used herein are selected from the group consisting of ions of sodium, lithium, magnesium, zinc and mixtures therefrom. Yet more preferably, the metallic ions used herein are selected from the group consisting of ions of sodium, zinc and mixtures therefrom. The parent acid copolymers of the invention may be neutralized as disclosed in U.S. Pat. No. 3,404,134.

By “degree of neutralization” is meant the mole percentage of acid groups on the ethylene copolymer that have a counterion. The ethylene acid copolymer utilized in the present invention is neutralized to a level of about 70% to slightly greater than 100% with one or more metal ions selected from the group consisting of potassium, sodium, lithium, magnesium, zinc, and mixtures of two or more thereof, based on the total carboxylic acid content of the acid copolymer.

A copolymer may also be applied to the fabric surface in the form of a dispersion, and the copolymer may be applied with the ethylene acid copolymer. The copolymer may also be plasticized. Any suitable plasticizer may be selected by one skilled in the art, for example the plasticizer is selected from the group consisting of fatty acids or fatty alcohols

The composite article of the invention may also contain one or more layers of high strength polyolefin fiber composites such as the cross-plied unidirectional polyethylene fiber composite Dyneema HB26 from DSM Co. (Netherlands).

The fibers which are utilized in the composite may comprise hybrids, for example, aramid and carbon; aramid and glass; aramid, carbon and glass; carbon, glass and extended chain polyethylene, etc. Hybridization of the fibers not only reduces costs, but in many instances improves the performance in armor structures. It is known that aramid fiber and carbon are significantly lighter than glass fiber. The specific modulus of elasticity of aramid is nearly twice that of glass, while a typical high tensile strength-grade of carbon fiber is more than three times as stiff as glass in a composite. However, aramid fiber has a lower compressive strength than either carbon or glass, while carbon is not as impact resistant as aramid. Therefore, a hybrid of the two materials results in a composite that is (1) lighter than a comparable glass fiber-reinforced plastic; (2) higher in modulus, compressive strength and flexural strength than an all-aramid composite; and (3) higher in impact resistance and fracture toughness than an all-carbon composite.

In one embodiment, plasticizers, surfactant or wetting aids are added to aqueous dispersions and emulsions to prevent dewetting on the repellant aramid fabrics. Sodium dodecyl sulfate (SDS), Alkanol 6112 (DuPont, Wilmington, Del.), Zonyl® FSA(DuPont, Wilmington, Del.), 1-decanol, Surfynol® 440 (Air Products, Co., Allentown, Pa.), Environgen 360® (Air Products, Co), Dynol® 607 (Air Products, Co), Aerosol OT-DG (Cytec, Co.), Ethal EH-5 (Ethox Co.), Foryl 5999 (Pulcra, Co), Genapol X080 (Clariant Co.) and many other surfactants can be used.

Thickeners such as high molecular weight (MW=6×10̂6 g/mol) polyethylene oxide, cellulose, gelatin and many other polymers, silica, and clays can also be used in the dispersions and emulsions to facilitate coating uniformity on the repellant aramid fabrics during drying. Other commercially available thickeners include Acrysol ASE-75 and Acrysol RM-6000 from Rohm and Haas, Co. These thickeners can be mixed with surfactants as is well known in the art.

Some Kevlar® fabric used in the indicated studies below had a repellant fluorocarbon treatment. Fabrics studied here were treated with a fluorinated acrylate copolymers or methacrylate copolymers. Zonyl® D from DuPont is an example, and these repellant fluorocarbon treated Kevlar® fabrics are sold as S751-F. Untreated non-repellant Kevlar® fabric (S751-G) is also used here. All fabrics were obtained from JPS Composites, Co (Greenville S.C.). Peel tests were carried out at a 90 or 180 degree peel angle at 20 C. Reported values were obtained with methods including ASTM D 1876-08.

### EXAMPLES

For all the Examples and Comparative Examples except Comparative 3, water based resin coatings were applied on one side of the fabric before stacking layers and pressing them into multilayer composite articles for ballistic testing.

Twelve inch wide strips of woven fabric were rod coated with the aqueous dispersions or emulsions of the polymers indicated in Tables 1 and 2. Depending on the solids, a thick liquid layer is deposited with these methods, which is then dried under various conditions. For the examples here, 20° C. overnight on the benchtop was used, but in other cases drying ovens for a few minutes at 100° C. to 150° C. were used. The thickness of the liquid layer was adjusted by choosing different rod sizes and levels of dilution of the coating solution. This would then give the correct solid coating weight fraction as a function of the weight of the Kevlar® fabric. Many other standard liquid coating methods are suitable including slot die, spray, roll, transfer, graviere, dip coating, and related methods. One or both sides of the fabrics can be coated.

For Table 1 describing Examples 1, and Comparative Examples 2-5, a Tokorev projectile was used for ballistic tests with 1.6 psf (1127 kg/m2) areal density composite articles that were pressed for 20 minutes at 500 psi (352,000 kg/m2) and at 160° C.

Example 1 consists of a coating of Michem 4983 (Michelman Co., Ohio) which is an aqueous dispersion of Ethylene-Acrylic Acid (E-AA) copolymer (Michem 4983 contains 20 mol % AA comonomer). The weight percent Michem 4983 resin after drying is 13 wt % based on Kevlar* S751-F fabric and is low enough to give low peel strengths. (Table 1) It is a low melting, low crystallinity resin (Tm=72° C.) without metal ion neutralization.

Comparative Example 2 consists of a coating of Michem 4983 (Michelman Co., Ohio). The weight percent Michem 4983 resin after drying is 18 wt % on Kevlar* S751-F fabric which is high and results in high peel strengths.

Comparative Example 3 consists of a solid film of PVB-phenolic thermoset resin that was formed in an earlier step. These films were inserted between Kevlar* S758 fabric layers and pressed into composite articles at 160° C./500 psi for 15 minutes.

Comparative Example 4 consists of a Sancure 20025 polyurethane emulsion (Lubrizol Co.). This is a thermally curable thermoset and gives a strong elastomeric low Tg film.

Comparative example 5 consists of a Permax 200 polyurethane emulsion (Lubrizol Co.) This is a thermally cured thermoset and gives a strong elastomeric low Tg film.

For other tests in Table 2, a 17 grain fragment was used. Peel tests were carried out at 20 C.

Table 1 shows the V50 results for the examples and comparative examples studied here. Lower peel strength correlates with high V50. V50 is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target.

TABLE 1
V50 results for 1.6 psf composite articles pressed at 160° C./
500 psi for 15 minutes, and shot with Tokorev projectile

| | | Number of | | Peel | |
|---|---|---|---|---|---|
| | | Fabric | | Strength | V50 |
| Item | Fabric | Layers | Resin | (kg/cm) | (ft/sec) |
| Example 1 | S751-F | 43 | Michem | 0.8 | 1875 |
| | | | 4983 (13%) | | |
| Comp. Ex. | S751-F | 40 | Michem | 1.5 | 1734 |
| 2 | | | 4983 (18%) | | |
| Comp. Ex. | S758 | 17 | PVB-Phenolic | 1.5 | 1718 |
| 3 | | | film (12%) | | |
| Comp. Ex. | S751-F | 44 | Sancure | 1.8 | 1760 |
| 4 | | | 20025 (18%) | | |
| Comp. Ex. | S751-F | 43 | Permax 200 | 2.0 | 1660 |
| 5 | | | (13%) | | |

For the Examples and Comparative Examples in Table 2, a different projectile was used and thicker composite articles were studied. A 17 grain fragment simulating projectile was impacted into a number of 2.1 to 2.2 pound per square foot (psf) composite articles containing 55 to 64 layers of fabric that were pressed at 500 psi. The V50 results were then normalized to exactly 2.2 psf for easy comparison and summarized in Table 2. Example 6 consists of a coating of Michem 4983 with a dry coating weight percent of 12 wt % on Kevlar* S751-F fabric. Because of this resin and the poor adhesion to the fluoro-treated S751-F fabric after pressing the composite article at 160° C., low peel strengths of the layers in the pressed composite article are observed. (Table 2).

Example 7 consists of a coating of Permax 200 polyurethane emulsion (Lubrizol Co.) with a dry coating weight percent of 11 wt % on Kevlar* S751-F fabric. Because of this thermoset resin was incompletely cured due to the low pressing temperature of 126° C., and due to the poor adhesion to the fluoro-treated S751-F fabric, low peel strengths of the layers in the pressed composite article are observed. (Table 2).

Comparative Example 8 consists of a coating of Michem 4983 with a dry coating weight percent of 13 wt % on Kevlar* S751-G fabric. Because of this resin and the good adhesion to the non repellant S751-G fabric after pressing the composite article at 160° C., high peel strengths of the layers in the pressed composite article are observed. (Table 2).

Comparative Example 9 consists of a coating of Permax 200 with a dry coating weight percent of 13 wt % on Kevlar* S751-G fabric. Because of this resin and the good adhesion to the non repellant S751-G fabric after pressing the composite article at 160° C., high peel strengths of the layers in the pressed composite article are observed. (Table 2).

Example 10 comprises a Michem 2960 (Michelman Co., Ohio) dispersion of ethylene-acrylic acid (E-AA) copolymer (10 mol % AA comonomer) coated onto S-751-F and pressed into a 2.2 psf composite article at 500 psi. The counterion was potassium in 2960 making this resin an ionomer. The resin solids were 9.7 wt % based on the fabric weight.

It is seen in Table 2 that low peel strengths caused by the incorporation of S751-F fabric in the pressed composite articles leads to high V50, while high peel strengths resulting from the use of S751-G with the same resins, respectively, leads to low V50.

TABLE 2
17 Grain Projectile Tests on 2.2 psf Composite articles.

| | Peel Strength | V50 |
|---|---|---|
| Sample | Kg/cm | Feet/sec |
| Example 6 | 0.80 | 2560 |
| Example 7 | 0.65 | 2607 |
| Comparative 8 | 1.2 | 2231 |
| Comparative 9 | 1.3 | 2300 |
| Example 10 | 0.77 | 2830 |

We claim:

1. An impact resistant composite article comprising two or more fibrous fabric layers and a polymeric layer disposed between at least some of the fabric layers, in which the peel strength measured at 20° C. between the fabric layer and an adjacent polymeric layer after pressing for 20 minutes at 500 psi and 160° C. is less than 1 kg/cm, and where the weight % of polymeric resin relative to the resin plus fabric is between 8% and 15% and where the polymeric layer comprises a material selected from the group consisting of a thermoplastic material, a blend of thermoplastic materials, a thermosetting material, a blend of thermosetting materials, and mixtures thereof; and where the polymeric layer does not contain a thermoplastic material and a thermosetting material.

2. The composite article of claim 1 in which the weight % or polymeric resin relative to the resin plus fabric is between 10% and 13%.

3. The composite article of claim 1 in which the fabric layer is at least partially woven.

4. The composite article of claim 1 in which the fabric layer comprises a polymer selected form the group consisting of aramid, UHMWPE, UHMWPP, poly vinylalcohol, polyazole and combinations or blends thereof.

5. The composite article of claim 3 in which the fabric comprises poly (p-phenylene terephthalamide).

6. The composite article of claim 1 which comprises an acid ethylene copolymer disposed between at least two of the fabric layers

7. The composite article of claim 6 in which the ethylene copolymers are neutralized with an ion selected from the group consisting of sodium, potassium, lithium, silver, mercury, copper (I), beryllium, magnesium, calcium, strontium, barium, copper (II), cadmium, mercury, tin, lead, iron, cobalt, nickel, zinc, aluminum, scandium, iron, yttrium, titanium, zirconium, hafnium, vanadium, tantalum, tungsten, chromium, cerium, iron and combinations thereof.

8. The composite article of claim 1 in which the fabric is repellant coated.

9. The composite article of claim 1 in which the fabric is at least partially finished with a fluorinated material.

10. The composite article of claim 9 in which the fluorinated material is selected from the group consisting of fluorinated acrylate copolymer and a fluorinated methacrylate copolymer.

11. The composite article of claim 1 in which the polymer layer further comprises a material selected form the group consisting of a surfactant, a plasticizer, and a mixture or combination thereof.

12. The composite article of claim 11 in which the surfactant is 1-decanol.

13. A panel comprising the composite article of claim 1.

14. A helmet comprising the composite article of claim 1.
